(19) United States
(12) Patent Application Publication
(10) Pub. No.: US 2006/0105766 A1
(43) Pub. Date: May 18, 2006

(54) Method for delivering a call to a dual-mode mobile unit using a single number

(76) Inventors: Maria Rg Azada, Naperville, IL (US); Richard Paul Ejzak, Wheaton, IL (US); Ruth Schaefer Gayde, Naperville, IL (US); Donna Michaels Sand, Redmond, WA (US); Robin Jeffrey Thompson, Batavia, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/259,533

(22) Filed: Oct. 25, 2005

Related U.S. Application Data
(60) Provisional application No. 60/622,067, filed on Oct. 26, 2004.

(51) Int. Cl. H04Q 7/20

(52) U.S. Cl. 455/432.1; 455/461

(57) ABSTRACT

The present invention provides a method for delivering a call request to a mobile unit. A call request is received for a dual mode mobile unit that is able to access a plurality of communication networks utilizing a plurality of communication protocols. The call request is routed to a call delivery application server, which determines which of the communication networks to deliver the call request. The call request is sent to the determined communication network.

### CROSS-REFERENCE TO RELATED APPLICATION

This application claims the benefit of Provisional Application Ser. No. 60/622,067, filed Oct. 26, 2004.

### FIELD OF THE INVENTION

The present invention relates generally to communication systems, and more particularly to a method for delivering a call to a dual mode mobile unit.

### BACKGROUND OF THE INVENTION

In communication systems, a mobile unit is contacted by dialing a directory number associated with the mobile unit. Newer mobile units have the capability to register with multiple communication networks. However, such a dual-mode mobile unit requires a directory number for each communication network that it registers with. This requires a caller to know multiple directory numbers for a mobile unit.

A dual-mode mobile unit can alleviate this problem by activating a call-forwarding feature, so that calls to this unit from the first network are forwarded to the second network. Call-forwarding is a network feature that allows a user to forward calls placed to a first number to a second number. One problem with this approach is that a user has to manually activate and deactivate call forwarding. A user can miss incoming calls if call forwarding is not deactivated, even when located in the intended location area. Furthermore, this solution requires the use of two directory numbers, which may be undesirable where available directory numbers are scarce.

Therefore, a need exists for a method of alerting a dual-mode mobile unit without employing multiple phone numbers for the mobile unit. Further, a need exists for a method for receiving calls at a dual-mode mobile unit without having to activate call-forwarding functionality.

### BRIEF SUMMARY OF THE INVENTION

The present invention provides a method for supporting call delivery via a single number to an IMS subscriber while the IMS subscriber is either in IMS or is roaming in the circuit network.

An IMS (IP Multimedia Subsystem) is the 3GPP and 3GPP2 standards-based solution which provides IP based services including VoIP. One proposed implementation is a combined IMS-based VoIP (Voice over IP) and circuit wireless network, such as CDMA, GSM or other legacy mobile network. In one exemplary embodiment, an IMS-based VoIP service is provided and integrated with broadband services such as 802.11 (WiFi), CDMA HRPD, or UMTS HSDPA where coverage is available. Existing circuit wireless service is provided in areas where the broadband services are not available. This combined service provides an enhanced communication network for both existing wireless service providers and other service providers just entering the wireless arena. Advantages of the present invention include enhanced services available in the IP domain and the ability to offload the circuit network spectrum by using VoIP in broadband spectrum, some of which is unlicensed.

The present invention provides a solution to the problem of support for call delivery to an appropriate network, such as an IMS or circuit network, while requiring only one number to be assigned to the dual mode user. The present invention solves this issue by including an enhanced Gateway MSC function on a Call Delivery Application Server in an IMS network. In accordance with an exemplary embodiment of the present invention, calls to a combined IMS VoIP/Circuit roaming user are delivered to the IMS system, where the enhanced Call Delivery Application Server preferably makes the determination to deliver the call within the IMS or the circuit network based on user preference and registration status in the IMS and circuit networks. If the call is to be delivered into the IMS network, the Call Delivery Application Server directs the call into the call processing and application servers within the IMS network. If the call is to be delivered into the circuit network, the Call Delivery Application Server queries the circuit network HLR to retrieve the temporary routing number of the called phone, such as the TLDN (Temporary Local Directory Number) or the MSRN (Mobile Station Roaming Number) from the current serving circuit network MSC. The call can then be delivered using that routing number.

In accordance with a further exemplary embodiment of the present invention, the Call Delivery Application Server queries the HLR for termination features such as call forwarding, incoming call barring, or do not disturb. The appropriate features can then be offered to the end user regardless of whether the subscriber is being served in the IMS network or the circuit network.

The present invention also provides improved call setup times. In accordance with an exemplary embodiment, the IMS and the circuit network begin call delivery in parallel. Specifically, while delivery is being attempted in the IMS, the temporary routing number required for a call delivery attempt in the circuit network can be requested. If the IMS call delivery fails, the information necessary to deliver the call to the circuit network is available to the Gateway MSC and that call can be routed without delay.

The present invention provides call delivery via a single number for a dual mode IMS and circuit network user. In accordance with an exemplary embodiment, this is provided by a Call Delivery Application Server. Further, the Call Delivery Application Server allows the standard MSC-to-HLR interface, thus allowing existing HLRs to remain in place with no operational changes. The Call Delivery Application Server is preferably a logical entity that provides terminating features, such as terminating triggers and call forwarding, as directed by the circuit network HLR. Thus a dual-mode IMS/Circuit network user can be provisioned with features in the HLR and have consistent access to that call treatment in either the IMS or circuit network. The present invention allows IMS system providers to support call delivery to dual-mode IMS and legacy circuit network roaming mobile units, where the dual mode mobile unit can be reached using a single directory number. The mobile user can be reached using a single directory number, whether the mobile user is located in the IMS or the circuit network.

### BRIEF DESCRIPTION OF THE SEVERAL VIEWS OF THE DRAWINGS

FIG. 1 depicts an IMS and circuit roaming system in accordance with an exemplary embodiment of the present invention.

FIG. 2 depicts a call flow of an IMS-terminated call in accordance with an exemplary embodiment of the present invention.

FIG. 3 depicts a call flow of a circuit-terminated call in accordance with an exemplary embodiment of the present invention.

### DETAILED DESCRIPTION OF THE INVENTION

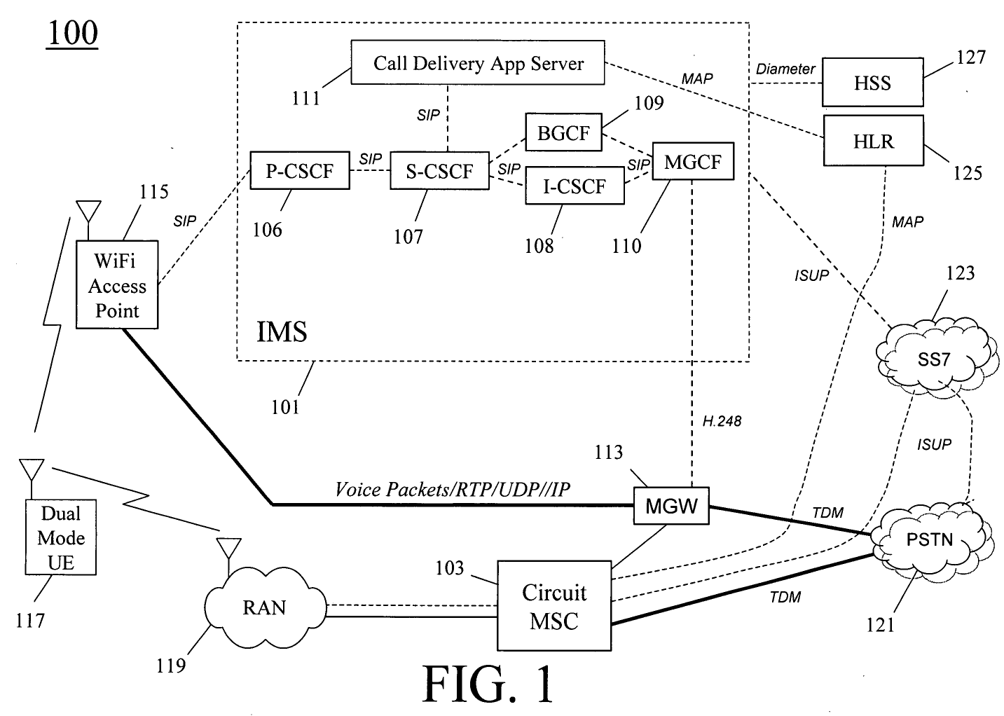

FIG. 1 depicts an IMS and circuit roaming system 100 in accordance with an exemplary embodiment of the present invention. System 100 includes IMS (IP Multimedia Subsystem) 101, circuit MSC (Mobile Switching Center) 103, WiFi Access Point 115, RAN (Radio Access Network) 119, PSTN (Public Switched Telephone Network) 121, SS7 (Signaling System 7) 123, HLR (Home Location Register) 125, and HSS (Home Subscriber Server) 127.

IMS 101 is responsible for call and session control provided by the IMS in the subscriber's home network. IMS Server 101 manages SIP sessions, provides features and services, coordinates with other network elements for session control, and allocates media resources.

IMS Server 101 includes a plurality of functions and components, which may be installed on separate servers or can alternately share the same server. This allows for flexible packaging for various customer needs. IMS 101 comprises P-CSCF (Proxy Call Session Control Function) 106, S-CSCF (Serving CSCF) 107, I-CSCF (Interrogating CSCF) 108, BGCF (Breakout Gateway Control Function) 109, MGCF (Media Gateway Control Function) 110, and Call Delivery Application Server 111. IMS Server 101 is connected to MGW (Media Gateway) 113.

P-CSCF 106 is preferably the first contact for a SIP mobile unit to gain access to IMS 101 from the access packet network domain. P-CSCF 106 provides the necessary SIP routing capability between SIP mobiles and IMS 101. P-CSCF 106 also coordinates with the access network to authorize the resources and Quality-of-Service (QoS). For services that are offered by the home IMS network, P-CSCF 106 relays the SIP signaling to the IMS server in the home network.

S-CSCF 107 manages SIP sessions and coordinates with other network elements for call/session control. S-CSCF 107 performs SIP registration, session control, service control, call monitoring, and security. SIP registration comprises processing SIP REGISTER requests and maintaining subscriber data and state information for the duration of the registration session. Session control comprises performing call/session setup, modification, and termination. Service control comprises interaction with Application Services platforms for the support of features and services. Call monitoring comprises call monitoring and recording for accounting and other related services. Security comprises providing security for the session.

SIP user clients communicate to the various application servers via S-CSCF 107. S-CSCF 107 provides the messaging filtering, message forwarding, and transaction and session control functions for the sessions initiated by SIP signaling. S-CSCF 107 also allows the various SIP-based application servers to communicate with each other. S-CSCF 107 also preferably provides SIP proxy functions for forwarding SIP messages to the proper application server and allowing application servers to subscribe to SIP dialogs between SIP clients and servers.

Because S-CSCF 107 supports standard SIP messages, the user clients and SIP application servers can span a wide variety of telephony and non-telephony services. For example, S-CSCF 107 can provide the message filtering and forwarding for SIP-based services such as Instant Messaging (IM), Push-To-Talk, and multimedia services.

I-CSCF 108 is the contact point within system 100 for all connections destined to a subscriber connected to system 100 or a roaming subscriber currently located within the service areas supported by system 100. System 100 may include multiple I-CSCFs. I-CSCF 108 assigns an S-CSCF to a user performing SIP registration. I-CSCF 108 also obtains from HSS 127 the address of S-CSCF 107 and uses the address to route a SIP request or response received from a network towards S-CSCF 107.

In accordance with an exemplary embodiment of the present invention, the functions of I-CSCF 108 are hidden from outside systems. Examples of functions that can be hidden include, but are not limited to, the configuration, capacity, and topology of the IMS 101. When the functions of I-CSCF 108 are being hidden, I-CSCF 108 forwards SIP requests and responses to an I-CSCF on another network for sessions traversing multiple networks. This allows network operators to maintain configuration independence.

BGCF 109 selects the network in which PSTN breakout is to occur. If BGCF 109 determines that the breakout is to occur in the same network where BGCF 109 is located, BGCF 109 selects a Media Gateway Control Function (MGCF). The MGCF is responsible for the interworking with the PSTN network. If the breakout is in a different network, BGCF 109 forwards this session signaling to a BGCF, or an MGCF, depending on configuration, in the different network.

MGCF 110 provides the signaling inter-working functions between IMS 101 and PSTN 121. MGCF 110 controls a set of media gateways, such as MGW 113, utilizing H.248 signaling. The use of H.248 signaling allows MGCF 110 to control establishment of bearer resources for sessions that require inter-working for bearer traffic between the PSTN 121 and IMS 101.

Call Delivery Application Server 111 is an application server that provides the call delivery function for communication system 100. In an exemplary embodiment, there may be multiple application servers. Call Delivery Application Server 111 preferably provides service logic as part of a call or session between two user endpoints.

The CSCF uses filter criteria to include Call Delivery Application Server 111 for service logic as directed by the per-subscriber data from HSS 127.

S-CSCF 107 uses filter criteria to involve Call Delivery Application Server 111 for call delivery determination and as needed to provide features and services. Filtering is done in S-CSCF 107 on SIP request messages only, such as INVITE, REGISTER, SUBSCRIBE, BYE, but not on responses to requests. Filtering can be based on such things as the method of the SIP request, on whether the request was received in the originating or terminating case, on whether a particular media type is included in the SDP of a request, or on the presence or content of a particular SIP header.

A specific user may get services from more than one Application Server. A Filter Criteria applies to one specific Application Server and the service profile of a user contains a set of Filter Criteria. During registration of a user, S-CSCF 107 obtains the set of initial Filter Criteria from HSS 127 that gives information about the Application Server(s) that need to be involved for the user, under which circumstances each gets involved, and the priorities of the Filter Criteria. At the time of registration, S-CSCF 107 sends a third-party REGISTER request to each Application Server whose Filter Criteria have a match for the REGISTER event. A Application Server can then get additional Application Server-specific data from HSS 127, if needed.

When S-CSCF 107 receives from the user a SIP request for a dialog, it evaluates the highest priority initial Filter Criteria. If the SIP request matches the filter criteria, S-CSCF 107 proxies the SIP request to the corresponding Application Server. The Application Server performs service logic, may modify the SIP request, and may send the request back to S-CSCF 107. The output of the first Application Server, if it satisfies the initial filter criteria for the second Application Server, is the input of the second Application Server, and so on. The sequence order of the Application Server(s) is based on the relative priorities of their respective initial Filter Criteria obtained from HSS 127 at registration time.

The service logic performed by Call Delivery Application Server 111 may result in a negative response to the SIP request. In this case, S-CSCF 107 will not evaluate any lower priority initial Filter Criteria and their corresponding Application Server(s) providing other services will not be reached.

Call Delivery Application Server 111 implements at least those capabilities of a Gateway MSC in a legacy cellular network that are needed to perform call delivery to Dual Mode UE 117 when the Dual Mode UE 117 is registered at an HLR 125 within a circuit-mode cellular network. Call Delivery Application Server 111 preferably has a MAP interface to HLR 125. Call Delivery Application Server 111 appears to HLR 125 as if it were a standard Gateway MSC within the legacy cellular network by performing standard MAP call delivery and profile access procedures. Call Delivery Application Server 111 may also query HLR 125 to retrieve HLR-based terminating feature information for different flavors of call forwarding, call barring, terminating triggers, etc. Call Delivery Application Server 111 may provide these features to Dual Mode UE 117 whether the call is delivered via the IMS or the circuit-mode cellular network.

Since Call Delivery Application Server 111 is an Application Server, it can also receive third-party registration information from S-CSCF 107, which details the registration status of Dual Mode UE 117 within IMS 101. When receiving a new call termination for the subscriber according to standard IMS call delivery procedures, Call Delivery Application Server 111 uses information about the registration status of Dual Mode UE 117 within IMS 101 and the circuit-mode cellular network to determine whether to deliver the call to Dual Mode UE 117 via P-CSCF 106 and packet access network, e.g., the WiFi Access Point 115, or via the circuit-mode cellular network, e.g., Circuit MSC 103 and RAN 119. If Dual Mode UE 117 is registered in both networks, Call Delivery Application Server 111 may choose to attempt delivery via either one network or both, and in any sequence and timing, including simultaneously.

Media Gateway (MGW) 113 provides bearer traffic connectivity to PSTN 121, preferably via asynchronous, synchronous and optical terminations. MGW 113 is also able to communicate with other Public Land Mobile Networks (PLMNs). MGW 113 also provides echo cancellation and some tone generation. MGW 113 preferably is controlled from MGCF 110 using the H.248 standard over an IP switching fabric.

MGW 113 preferably includes digital signal processors (DSPs) that provide a path between the IP multimedia domain and the circuit switched environment, including PSTN 121, for bearer traffic. MGW 113 supports media conversion, bearer control, and payload processing. The DSPs preferably support G.711 (A & μ law), G.723.1 at either 6.3 Kbps or 5.3 Kbps and G.729 at 8 Kbps, EVRC, AMR and 4GV. The DSPs also provide E.168 echo cancellation and silence suppression with comfort noise generation in MGW 113.

Circuit MSC 103 connects landline PSTN system 121 to the mobile phone system. Circuit MSC 103 is also responsible for compiling call information for accounting and handing off calls from one cell to another.

Access Point 115 is an access dependent device that permits access to IMS 101. Access points are typically stand-alone devices that plug into an Ethernet hub or switch. Access points cover a certain range, perhaps as much as a thousand feet, and mobile users are automatically handed off from one to the other as they walk to other offices or locations. WiFi Access Point 115 can be a WiMAX network, an HSPD network, or an HSPDA network.

RAN 119 is the radio access network providing circuit-mode access to the PSTN via Circuit MSC 103 for Dual Mode UE 117 when registered with the circuit-mode cellular network at HLR 125.

PSTN 121 is the current narrowband-based telephone network that was designed for voice traffic.

SS7 123 is an out-of-band signaling network that carries call control and transaction messages for the PSTN, ISDN, Intelligent Network, and PLMN.

HLR 125 is a database in communication system 100 that includes all the home subscribers within the service area of the circuit-mode cellular network served by Circuit MSC 103 and RAN 119. When a subscriber reaches a new service area in the circuit-mode cellular network, the data in HLR 125 is requested and transferred via SS7 123 to a VLR (Visitor Location Register) associated with a Circuit MSC 103 in the new area.

HSS 127 is the master subscriber database for IMS 101 and includes registration status and subscription data for users. The data within HSS 127 is used by the different network core functional entities in IMS 101 when processing subscribers. HSS 127 includes user data that can be downloaded to S-CSCF 107. HSS 127 stores temporary data with the location of S-CSCF 107 where the user is currently registered. HSS 127 and HLR 125 may be co-located.

Dual Mode UE 117 is a subscriber device that is preferably capable of operating in either or both of two modes. One mode provides for registration and access to an IMS network via Access Point 115. The second mode provides for registration and access to a circuit-mode cellular network via RAN 119 and Circuit MSC 103. The selection of the operating mode(s) for the device depends on the availability of service from the networks and the capabilities of the device.

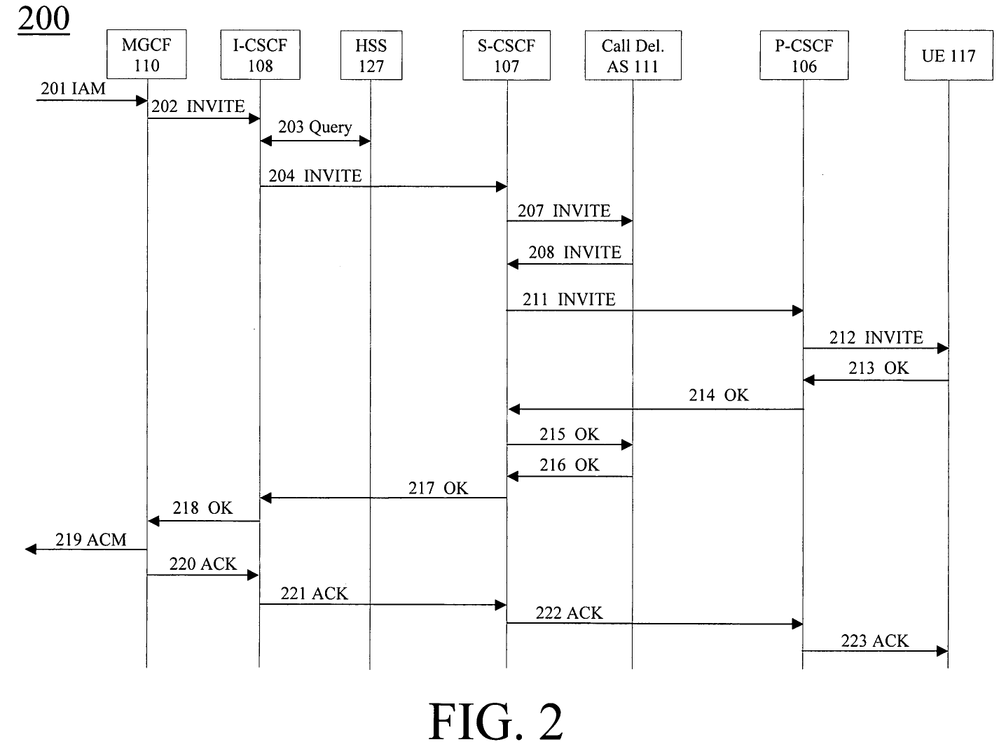

FIG. 2 depicts a call flow 200 of an IMS-terminated call in accordance with an exemplary embodiment of the present invention. In the embodiment depicted in FIG. 2, a call request has come in for dual mode user equipment 117 while dual mode user equipment 117 is located within the service area of IMS 101. FIG. 2 depicts the control messages sent to establish the call utilizing IMS 101.

If the called number is not normally routed directly to IMS 101 by PSTN 121, there are several mechanisms for achieving that end. In a first exemplary embodiment, the called number can be ported to IMS 101 using local number portability. In a further exemplary embodiment, termination triggers at the legacy home system can be used to get redirection instructions from an SCP. In a further exemplary embodiment, a long distance carrier code is assigned to IMS 101 and HLR 125 responds to the initial circuit network query with a routing number. The routing number is preferably the directory number of dual mode UE 117 with the carrier code of IMS 101 prefixed. The subsequent HLR query from the Call Delivery Application Server would preferably retrieve the real routing number rather than the carrier code and the mobile number.

PSTN 121 receives a call request for dual mode UE 117 and sends IAM message 201 to MGCF 110 of IMS 101. IAM message 201 includes the published directory number (PDN) of dual mode UE 117. In an exemplary embodiment, PSTN 121 sends IAM message 201 to MGCF 110 via SS7 123.

MGCF 110 sends Invite message 202 to I-CSCF 108. Invite message 202 includes the PDN of dual mode UE 117.

I-CSCF 108 queries HSS 127 with query message 203 to determine the serving CSCF for the call. HSS 127 returns the S-CSCF for this call to I-CSCF 108 in a return message.

I-CSCF 108 sends Invite message 204 to S-CSCF 107. Invite message 204 includes the PDN of dual mode UE 117. S-CSCF 107 preferably engages call delivery application servers based on predetermined filtering criteria to determine routing instructions for call delivery to this user.

S-CSCF 107 sends Invite message 207 to Call Delivery Application Server 111. Invite message 207 includes the PDN of dual mode UE 117. Since Call Delivery Application Server 111 receives third-party registration status information from S-CSCF 107, and Dual Mode UE 117 is currently registered in IMS 101 at HSS 127, Call Delivery Application Server 111 attempts call delivery to Dual Mode UE 117 using standard IMS call delivery procedures. Call Delivery Application Server 111 can optionally query HLR 125 to retrieve HLR-based terminating features, such as call forwarding immediate, call barring, and terminating triggers.

Call Delivery Application Server 111 provides the services indicated by HLR 125. Call Delivery Application Server 111 processes Invite message 207 and responds to S-CSCF 107 with Invite message 208.

S-CSCF 107 sends Invite message 211 to P-CSCF 106. Invite message 211 includes the PDN of dual mode user equipment 117.

P-CSCF 106 sends Invite message 212 to dual mode user equipment 117. In an exemplary embodiment, Invite message 212 is sent over-the-air to dual mode user equipment 117 via WiFi Access Point 115.

In the situation where user equipment 117 is busy or does not answer the call request, user equipment 117 sends a busy message or a timeout occurs at P-CSCF 106, indicating that the call is not being answered. Call Delivery Application Server 111 preferably sends a query to HLR 125 to obtain call forwarding information for dual mode user equipment 117. HLR 125 responds with the call forwarding forward-to number of user equipment 117. Call Delivery Application Server 111 sends an invite message to S-CSCF 107, which in turn sends an invite message to BGCF 109, which in turn sends an invite message to MGCF 110. At this point, MGCF 110 begins call setup to the destination identified by the forward-to-number.

In the exemplary embodiment depicted in FIG. 2, dual mode user equipment 117 responds to P-CSCF 106 with OK message 213. In the exemplary embodiment depicted in FIG. 2, typical IMS return signaling occurs. This is shown by messages 213 through 223. P-CSCF 106 responds to S-CSCF 107 with OK message 214. S-CSCF responds to Call Delivery Application Server 111 with OK message 215. S-CSCF 107 responds to I-CSCF 108 with OK message 217. MGCF sends OK message 218 to I-CSCF 108. MGCF 110 sends ACM message 219 to PSTN 121. MGCF 110 sends ACK message 220 to I-CSCF 108. I-CSCF 108 sends ACK message 221 to S-CSCF 107. S-CSCF 107 sends ACK message 222 to P-CSCF 106. P-CSCF 106 sends ACK message 223 to dual mode user equipment 117.

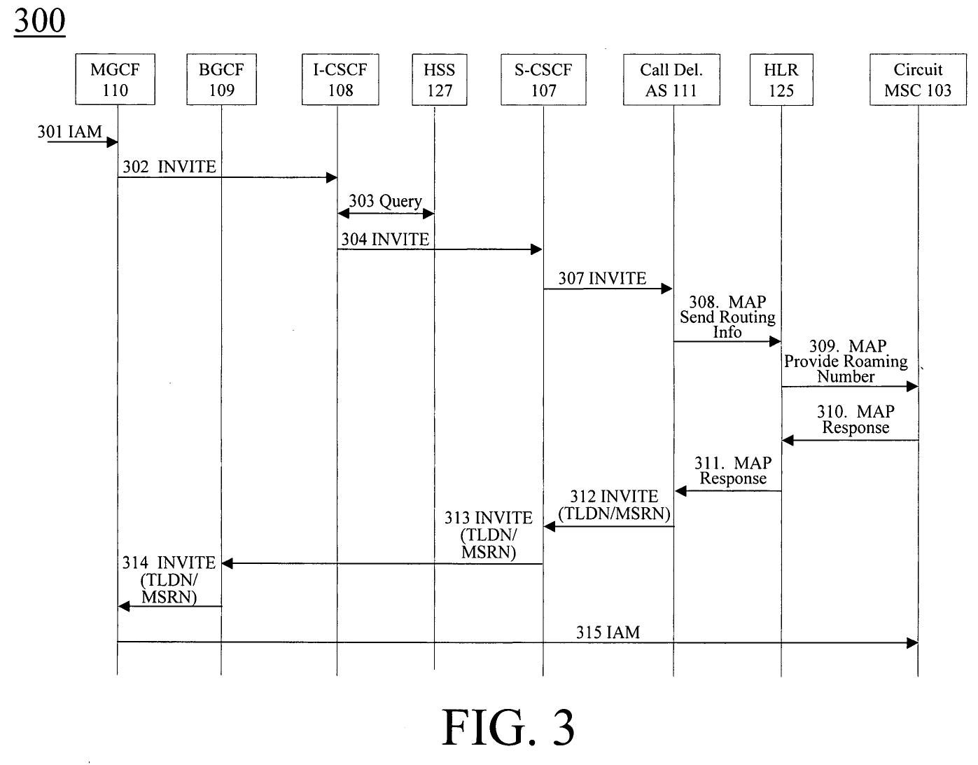

FIG. 3 depicts a call flow 300 of a circuit-terminated call in accordance with an exemplary embodiment of the present invention. In the embodiment depicted in FIG. 3, a call request has come in for dual mode user equipment 117 while dual mode user equipment 117 is located within the service area of Circuit MSC 103. FIG. 3 depicts the control messages sent to establish the call utilizing Circuit MSC 103.

PSTN 121 receives a call request for dual mode UE 117 and sends IAM message 301 to MGCF 110 of IMS 101. IAM message 301 includes the published directory number (PDN) of dual mode UE 117. In an exemplary embodiment, PSTN 121 sends IAM message 301 to MGCF 110 via SS7 123.

MGCF 110 sends Invite message 302 to I-CSCF 108. Invite message 302 includes the PDN of dual mode UE 117.

I-CSCF 108 queries HSS 127 with query message 303 to either determine the currently assigned serving CSCF for the call or to temporarily assign a serving CSCF for this session termination. HSS 127 returns the S-CSCF for this call, if the dual mode UE is currently registered and a S-CSCF is assigned to this subscriber. In the embodiment depicted in FIG. 3, dual mode UE 117 is not registered as an IMS endpoint at IMS 101.

I-CSCF 108 sends Invite message 304 to S-CSCF 107. Invite message 304 includes the PDN of UE 117. S-CSCF 107 preferably engages application servers based on predetermined filtering criteria to determine the routing instructions for call delivery to this user. In the embodiment depicted in FIG. 3, the user is unregistered, therefore the unregistered user filter criteria is applied. In this embodiment, the criteria includes the IMS terminating feature server followed by Call Delivery Application Server 111.

S-CSCF 107 sends Invite message 307 to Call Delivery Application Server 111. Invite message 307 includes the PDN of UE 117. Since Call Delivery Application Server 111 receives third-party registration status information from S-CSCF 107, and Dual Mode UE 117 is not currently registered in IMS 101 at HSS 127, Call Delivery Application Server 111 will attempt call delivery to Dual Mode UE 117 using circuit-mode cellular network call delivery procedures.

Call Delivery Application Server 111 queries HLR 127 with MAP Send Routing Info or ANSI41 LocationRequest message 308 to retrieve the circuit network based routing number and any HLR-based terminating features, such as call forwarding immediate, call barring, or terminating triggers. In an exemplary embodiment, the circuit network based routing number is an MSRN or TLDN. Call Delivery Application Server 111 optionally provides the services indicated by HLR 127.

HLR 125 sends MAP Provide Roaming Number or ANSI41 RouteRequest message 309 to Circuit MSC 103. If the call is to be delivered to the end user after HLR terminating features are applied, Call Delivery Application Server 111 continues the call out to the circuit network using the HLR-supplied MSRN/TLDN.

Circuit MSC 103 sends MAP Response message 310 to HLR 125.

HLR 125 sends MAP Response message 311 to Call Delivery Application Server 111.

Call Delivery Application Server 111 sends INVITE message 312 to S-CSCF 107. INVITE message 312 preferably includes the MSRN/TLDN of the Circuit MSC 103.

S-CSCF 107 sends INVITE message 313 to BGCF 109.

BGCF 109 sends INVITE message 314 to MGCF 110.

MGCF 110 sends IAM message 315 to Circuit MSC 103.

While this invention has been described in terms of certain examples thereof, it is not intended that it be limited to the above description, but rather only to the extent set forth in the claims that follow.

We claim:

1. A method for delivering a call request to a mobile unit, the method comprising:
receiving a call request for a mobile unit, the mobile unit being able to access a plurality of communication networks utilizing a plurality of communication protocols;
routing the call request to a call delivery application server;
determining at the call delivery application server which of the plurality of communication networks to deliver the call request; and
sending the call request to the determined communication network.

2. A method for delivering a call request to a mobile unit in accordance with claim 1, wherein the step of determining which of the plurality of communication networks to deliver the call request comprises determining which of the plurality of communication networks to deliver the call request based on a registration status of the mobile unit.

3. A method for delivering a call request to a mobile unit in accordance with claim 1, wherein one of the plurality of communication networks is an IMS (IP Multimedia Subsystem), and wherein the call delivery application server routes the call request to a call processing server within the IMS.

4. A method for delivering a call request to a mobile unit in accordance with claim 1, wherein one of the plurality of communication networks is a circuit network, the method further comprising the step of querying a Home Location Register (HLR) in the circuit network to retrieve a temporary routing number of the mobile unit.

5. A method for delivering a call request to a mobile unit in accordance with claim 4, wherein the temporary routing number comprises a TLDN (Temporary Local Directory Number).

6. A method for delivering a call request to a mobile unit in accordance with claim 4, wherein the temporary routing number comprises a MSRN (Mobile Station Roaming Number).

7. A method for delivering a call request to a mobile unit in accordance with claim 4, wherein the temporary routing number comprises the directory number of the mobile unit appended to a carrier code of an IMS (IP Multimedia Subsystem).

8. A method for delivering a call request to a mobile unit in accordance with claim 1, the method further comprising the step of querying an HLR for a termination feature.

9. A method for delivering a call request to a mobile unit in accordance with claim 8, wherein the termination feature comprises call forwarding.

10. A method for delivering a call request to a mobile unit in accordance with claim 8, wherein the termination feature comprises incoming call barring.

11. A method for delivering a call request to a mobile unit in accordance with claim 8, wherein the termination feature comprises a do not disturb feature.

12. A method for delivering a call request to a mobile unit in accordance with claim 1, the method further comprising the step of providing features to the mobile unit independent of the communication network to which the mobile unit is currently registered.

13. A method for delivering a call request to a mobile unit in accordance with claim 1, the method further comprising the step of determining that the mobile unit did not respond to the call request at the determined communication network.

14. A method for delivering a call request to a mobile unit in accordance with claim 13, the method further comprising the step of sending the call request to a second communication network of the plurality of communication networks.

15. A method for delivering a call request to a mobile unit in accordance with claim 14, wherein the step of sending the call request to the second communication network comprises utilizing a call forwarding number associated with the mobile unit.

16. A method for delivering a call request to a mobile unit in accordance with claim 1, wherein the step of routing the call request to a call delivery application server comprises utilizing local number portability.

17. A method for improving call setup time, the method comprising:
receiving a call request for a mobile unit, the mobile unit being able to access a plurality of communication networks utilizing a plurality of communication protocols; and
initiating in parallel call delivery to each of the plurality of communication networks.

18. A method for improving call setup time in accordance with claim 17, wherein the step of initiating in parallel call delivery to each of the plurality of communication networks comprises receiving a temporary routing number for the mobile unit.

19. A method for improving call setup time in accordance with claim 18, the method further comprising the step of sending the call request utilizing the temporary routing number if an initial routing of the call request fails.

20. A method for improving call setup time in accordance with claim 17, wherein the mobile unit is registered with an IMS (IP Multimedia Subsystem), the method further comprising the step of routing calls to the mobile unit via the IMS by requesting a routing number from the IMS.
